(19) United States
(12) Patent Application Publication
(10) Pub. No.: US 2013/0315355 A1
(43) Pub. Date: Nov. 28, 2013

(54) WIDEBAND SAMPLING WITH PHASE DIVERSITY

(71) Applicant: Lothar Vogt, Diekholzen (DE)

(72) Inventor: Lothar Vogt, Diekholzen (DE)

(21) Appl. No.: 13/880,955

(22) PCT Filed: Dec. 14, 2011
(86) PCT No.: PCT/EP2011/072748

§ 371 Date: Aug. 13, 2013

(30) Foreign Application Priority Data
Dec. 15, 2010 (DE) 10 2010 054 646.1

(51) Int. Cl. H04B 7/08

(52) U.S. Cl. CPC H04B 7/0814
USPC 375/347

(57) ABSTRACT

Method for operating a reception apparatus for radio-frequency signals, wherein at least two antennas (2, 4) for receiving and further processing the radio-frequency signals are provided, wherein the reception quality of the received radio-frequency signals is taken as a basis for effecting changeover, characterized in that the entire frequency range of the radio-frequency signals received by the respective antenna (2, 4) is converted from analogue to digital signals by means of a wideband converter (6, 7), and then frequency selection takes place.

The invention relates to a method of operating a receiver for radio-frequency signals as well as a receiver according to the characteristics of the preambles of the independent claims.

Methods of operating a receiver for radio-frequency signals are already in use in the field of automotive engineering, such as, for example, radio and television signals, where at least two reception paths having one antenna each for receiving and further processing the radio-frequency signals are provided, and switching between the reception paths is done depending on the reception quality of the respective received radio-frequency signals. Methods of this kind are referred to as antenna diversity systems and serve for improving the reception of radio-frequency signals, particularly for improving radio or television reception. The improvements regarding reception target a reduction of multipath interferences (caused by reflections of the received signals) by a suitable in-phase addition of at least two (or multiple) antenna signals, as well as achieving an aerial power gain to increase sensitivity.

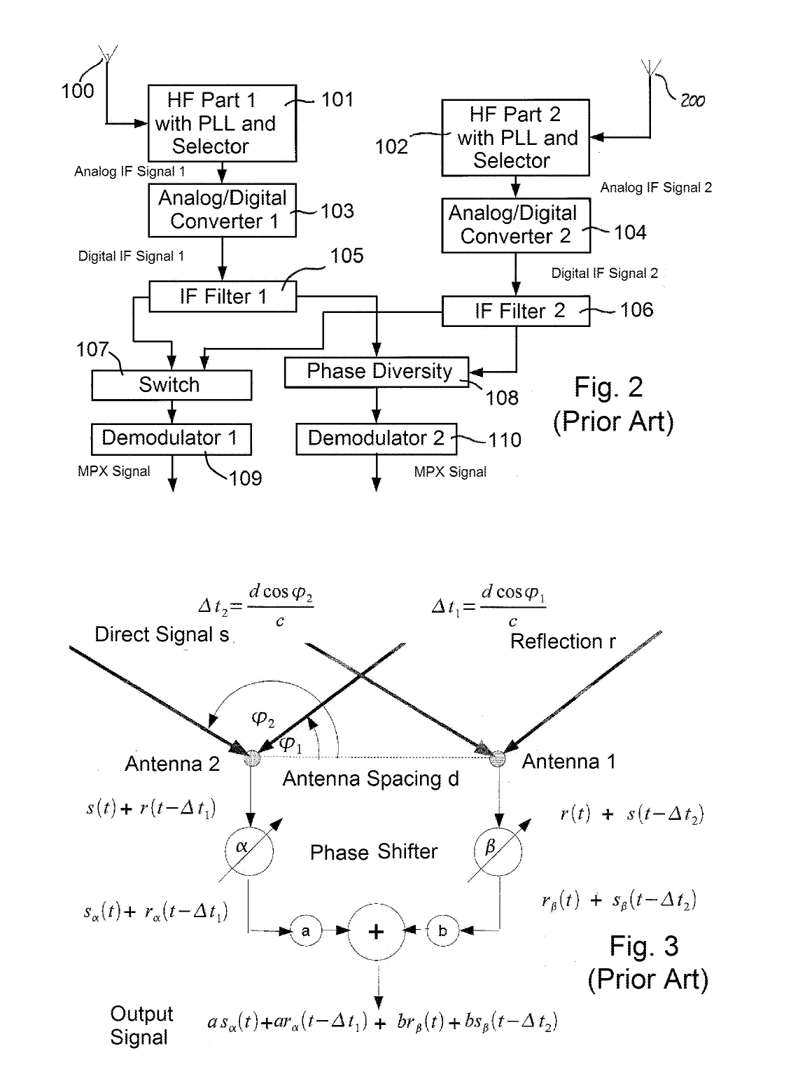

An antenna diversity system of this kind is shown as prior art in FIG. 2. Shown therein are two exemplary reception paths, where here an antenna 100, 200 is present in each of the reception paths 100, 200. Depending on the configuration of the antenna diversity system, more than two reception paths are also conceivable. A HF part 101, 102 is present in each reception path that is used for processing the radio-frequency systems that are received by the antennas 100, 200. This processing occurs such that using a phase-locked loop (PLL) and a corresponding selection process, the transmitting station that is to be received is selected from the received radio-frequency signals (sender frequency). Thereafter, using suitable and known means and algorithms, the selected radio-frequency signal is converted into a respective analog intermediate frequency signal (IF signal) that in turn is routed to a respective analog/digital converter 103, 104. The analog/digital converter converts the respective analog IF signal present at the input thereof into a digital signal using suitable and known algorithms. This digital IF signal at the output of the analog/digital converter 103, 104, however, does not need to be routed to an IF filter 105, 106. The output signals of the analog/digital converter 103, 104 can be unfiltered, or the output signals of the IF filter 105, 106 are routed to a changeover switch 107 and a phase-diversity unit 108. On the output side, the changeover switch 107 as well as the phase-diversity unit 108 are connected to respective demodulators 109, 110 that convert the routed digital IF signals into signals that are suitable for reproduction, particularly a multiplex signal (MPX signal). Corresponding reproduction devices are available but not shown in FIG. 2.

The methods of reducing multipath interferences by suitable in-phase addition of two or multiple radio-frequency antenna signals are basically known in the art, for example, under designations such as “phased diversity antenna” or “phased array antenna.” A method according to a “phased array antenna” of this kind is shown as prior art in FIG. 3.

The adjustment criteria of the unknown orders of magnitude α, β in the phase shifter and a, b as amplification or attenuation is effected according to known methods. In the event of test signal transmission, this is achieved by the so-called “Vienna solution,” or in the event of a blind equalization, for example, by the known “constant modulus algorithm” (CMA), or another suitable method.

The above-described methods are used increasingly for reception in automobiles, particularly radio reception in the very high frequency (VHF) range, because, owing to the continuously changing location, this application is highly susceptible to interference in the received radio-frequency signals triggered by reflections. In addition, the short-wave properties make the very high frequency signal also very susceptible to multipath reception interferences because of the modulation/demodulation process.

For improvement, switchover to an alternate frequency when using radio data systems (RDS) at a very high frequency has already been envisioned for situations when the reception is poor. Numerous methods are already in existence for this purpose that use one or more receivers. What these known systems and methods of processing received radio-frequency signals have in common is the fact that a phase-locked loop (PLL) implements this frequency switching within a short amount of time. However, due to the fact that a receiver (a reception path) can only adjust one frequency by phase control, the known diversity system operates only if both reception paths are tuned to the same receiving frequency. If, using the content of the data received via RDS, a frequency change is to be implemented, there are basically the possibilities of implementing a parallel change with the two reception paths or of splitting the diversity system for an advance examination of an alternative with one receiver, and/or for a separate evaluation of the signals of the at least two antennas via an auxiliary reception path, for example by a changeover switch.

However, these known systems and methods suffer from fundamental disadvantages. When both receivers change over from the one frequency to the other frequency at the same time, audible or visible interference occur at the gap in the signal that is caused by the transient period of the phase-locked loop. Disadvantageously, one cannot be sure that an alternate frequency does in fact offer better reception exactly at this given point in time. If the other possibility is used and the diversity system is split, an exact comparison of the audible or visible frequency under diversity with an alternate option without diversity is always imprecise and can therefore result in flawed decisions regarding the selection of what is in fact the best option.

Aside from optimization efforts to reduce interference within the signal, simultaneously, there also exists the wish to receive additionally, aside from the audible (or visible) frequency and an optimum strategy for the selection of suitable alternate frequencies, for example, traffic radio news or other services. Use of the audible or visible frequency is not necessary to receive further services. In most cases, additional receivers are installed for this purpose, or one of the two reception paths, as shown in FIG. 2, is used for a short period of time. However, this has the disadvantage that it is not possible to perform interference reduction by phase diversity for the audible or visible program.

The previously described disadvantages could be remedied, either completely or partially, by increasing the number of reception paths and of the respective HF parts with tuning units corresponding to the desired number of the transmitter frequencies that are to be monitored in parallel. However, this solution causes a disproportionate cost increase, such that, although an improvement of the receiving properties is in fact achieved with regard to the implementation of such systems, the related cost situation, however, is extremely unsatisfactory. This means that all solutions and strategies either suffer from a high level of cost disadvantages, or undesired performance compromises related to the receiving systems must be accepted.

Therefore, it is the underlying object of the present invention to provide a method of operating a receiver for radio-frequency signals according to the diversity principle, as well as a receiver that operates according to the method while avoiding the disadvantages as described in the introduction.

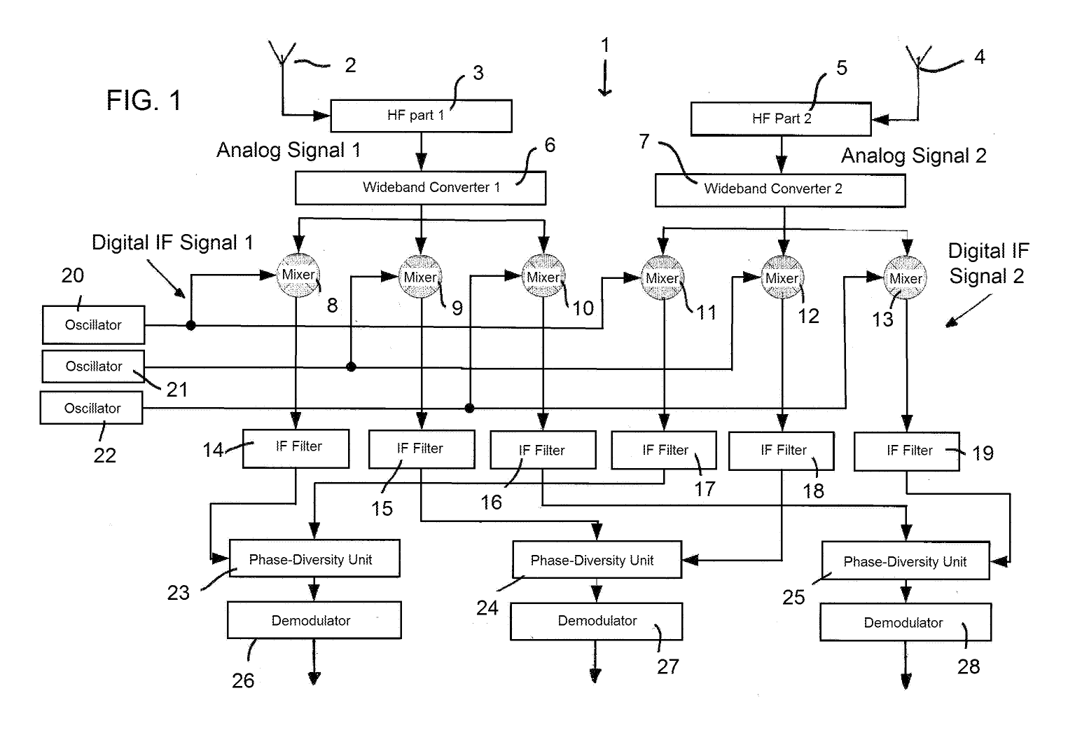

According to the invention, a method is envisioned in which the totality of the frequency range of the radio-frequency signals that are received by the respective antenna are converted from analog into digital signals by a wideband converter that is downstream of the one antenna, followed by a frequency selection. This means the basic idea of the invention is seen in the fact that, unlike as shown in FIG. 2, the selection of the frequencies to be played or shown (meaning from radio or television transmissions) is not performed in the radio-frequency range but, as shown in FIG. 1, in the low-frequency range, preferably in the intermediate frequency range. Owing to the advances in semiconductor technology, it is possible today, both in terms of performance as well as cost, to produce high-resolution analog/digital converters having very wide bandwidths. This type of high-resolution analog/digital converter (AD converters) with very wide bandwidths are presently referred to as wideband converters. For example, such a wideband converter is able to sample the entire VHF band from circa 88 MHZ to 108 MHZ, and the supplied radio-frequency analog signals are converted to corresponding digital radio-frequency signals.

An improvement of the invention provides for the digital signals to be routed to at least one mixer where the signals are multiplied by at least one signal of at least one oscillator in order to obtain at least one intermediate-frequency signal (IF signal). This means, therefore, that the mixing and selection of the desired frequency occurs at the digital level, followed by demodulation. Mixing occurs preferably as a multiplication of the output signal of the wideband converter with an output signal of an oscillator, preferably an output signal of a numerically controlled oscillator (NCO: numerical controlled oscillator). The IF frequency to which the signal is mixed down can be any suitable intermediate frequency greater than 0 MHZ in the digital range. In the alternative, it is conceivable to mix into the base band. This issue is not of crucial importance at the present time.

An improvement of the invention provides that the at least one IF signal is routed to an IF filter and filtered. This helps to advantageously eliminate further partial disturbances.

Below, referring to FIG. 1, the method according to the invention will be explained in further detail using an exemplary receiver for the embodiment of this method.

In FIG. 1, reference numeral 1 designates a receiver that is suited and configured for the implementation of the method according to the invention. The receiver 1 for wideband sampling with phase diversity here has three reception paths that will be explained in further detail below. However, the invention is not limited to these three reception paths, as four, five and more reception paths are possible as well. If this is the case, the number of the elements that must be described in connection with the receiver 1 in FIG. 1 is multiplied by that number.

In this context, an antenna 2 with HF part 5 downstream is provided in a reception path (contrary to the reception paths that were explained with regard to the prior art), wherein, analogous thereto, an antenna 4 with HF part 5 downstream is also provided in another part of the receiving path 5. The HF parts 3, 5 differ from the HF parts as represented in FIG. 2 in that they do not include a phase-locked loop and no selection of the received radio-frequency signals.

The received analog signals 1 and 2 are handed off from the output of the HF parts 3, 5 to a respective wideband converter 6, 7. This wideband converter 6, 7 is suitable and configured to convert the entire bandwidth of the analog signals 1, 2 of the HF parts 3, 5 from analog to digital signals. To be understood as the bandwidth is presently, for example for VHF, the band from circa 88 MHZ to 108 MHZ in the EU. This previously named bandwidth is only of an exemplary nature and can change depending on the bandwidth of the radio-frequency signals that are to be received as well as, if necessary dramatically.

Connected at the output of each of the wideband converters 6, 7 is at least one respective mixer. This means that the digital output signal of the respective wideband converter 6, 7 is routed to the respective mixer 8 to 13. In this embodiment, the wideband converter 6 has three mixers 8 to 10 and, similarly, the second wideband converter 7 is connected downstream to three mixers 11 to 13.

At this point, it is conceivable for each wideband converter 6 or 7 to have not exactly three mixers connected downstream but that only one or two or more than three mixers are downstream thereof.

The IF filters 14 to 19 can be, but do not have to be, present in a number corresponding to that of the available mixers 8 to 13. Using these IF filters 14 to 19, the output signals of the respective mixers 8 to 13 are filtered such that undesired signal parts that could result in interference are filtered out.

In order to tune the receiver 1 to the desired frequency (meaning the desired audible and/or visible transmitting station) the digital output signals of the respective wideband converters 6 and 7 are routed to the respective mixers 8 to 13 as described above, the signals being multiplied in the respective mixers 8 to 13 with at least one signal of at least one oscillator 20 to 22 in order to obtain at least one IF signal. In this embodiment, the oscillators 20 to 22 are configured as numeric oscillators (NCO: numerical controlled oscillator). The advantage therein lies in the fact that it is now possible to tune in the desired frequency very quickly, very cost-effectively and especially very precisely.

This means that the mixing (by multiplication) and selection of the desired frequency are made based on the digital level. The selection of the desired frequency (meaning of the transmitting station to be received) occurs in that either the unfiltered output signals of the mixers 8 to 13 or the output signals of the respective IF filters 14 to 19 are routed to a phase-diversity unit 23 to 25. The output signals of the phase-diversity units 23 to 25 are then routed to the respective demodulator 26 to 28 that supplies an output signal suitable for reproduction.

FIG. 1 shows that the digital output signals of the wideband converters 6 and 7 are routed to the respective mixers 8 to 13, then multiplied by the signals of the respective oscillators 20 to 22, and IF signals obtained in this manner are routed, filtered or unfiltered, to the respective phase-diversity units 23 to 25 whose output signals are routed to the respective demodulators 26 to 28. This means that the intermediate switching of the phase-diversity unit 23 to 25 between mixing and demodulation, as depicted in FIG. 1, makes it possible to implement phase diversity in a parallel manner for a plurality of frequencies by multiplication of the corresponding circuit parts. This means that a signal is applied, for example, at the output of the one demodulator that is currently to be heard or seen, while a simultaneous background search for alternate frequencies can be performed. If alternate frequencies are found, tuning can be carried out to use them, such that it is possible to decide afterward if switching is to occur for the reproduction of a program from one reception path having one frequency to another reception path for the purpose of reproducing an alternate frequency but with the same program having better reception properties (better reception quality such as, for example, a higher input level).

For purposes of clarification, references here made to the term “reception path” in the context of the description of the present invention are to be understood as indicated below.

The receiver as shown in FIG. 1 includes, on the one hand, a signal path of the radio-frequency signals from the antenna 2 via the HF part 3 to the first wideband converter 6. In addition, a further signal path is indicated that leads from the other antenna 4 via the HF part 5 to the wideband converter 7. Due to the fact that the mixers 8 to 13 and the subsequent elements are connected to the outputs of the respective wideband converters 6 and 7, the first reception path described here extends from the output of the wideband converter 6 via the mixer 8, if necessary via the IF filter 14, to the phase-diversity unit 23. Correspondingly, the other reception paths are set up in the same manner. In addition, a first total signal path ranges from antenna 2, via the HF part 3, further via the wideband converter 6, the mixer 8, if necessary the IF filter 14, via phase-diversity unit 23 to the demodulator 26. Analogously, there exists a further total signal path ranging from antenna 4, via the HF part 5, the wideband converter 7, the mixer 11, if necessary the IF filter 17, to the phase-diversity unit 23 and to the demodulator 26. Furthermore, it can be seen in FIG. 1 that the mixers 9, 10 and 12, 13 are constituted in the same manner in this context, as well as reception paths and total signal paths taking into account the antennas 2, 4, the HF parts 3, 5, as well as the wideband converter 6, 7.

Furthermore, based on the configuration of the receiver 1 according to FIG. 1, it is possible to tune to the same program that is to be played or shown, using the available reception paths with three different alternative frequencies. In the alternative, by the described method it is possible to tune to two alternate frequencies, with switching between the two depending on the quality of the reception, while, on the other hand, another program can be received by the third demodulator in the background. This third received program can be monitored, for example, for traffic radio news. The previously described number of reception paths with two antennas for three receiving frequencies is not preset with respect to number. For example, in a system with three antennas and three reception paths, it is possible to also analyze and process three frequencies. It is possible, however, to use more than three reception paths to tune to more than three transmitting stations. This means that by the multiplication of the corresponding circuit parts, as in the receiver 1 according to FIG. 1, it is possible to implement phase diversity for a plurality of frequencies in a parallel manner. The embodiment shown in FIG. 1 having two-way antenna diversity for three receiving frequencies can be implemented easily, having small dimensions and with great cost-effectiveness using modern semiconductor technology. Simultaneously, the computing speeds of the involved components are very great so that it is also possible to provide a circuit or a plurality of circuits as an arithmetic-logic unit in a multiplex.

An evaluation unit is connected to the outputs of at least two demodulators (for example, 26, 27 or 27, 28 or 26,28) or to more than two demodulators. This evaluation unit receives the signals from the respective demodulators and analyzes them based on criteria that can be preset. Such criteria are, for example, the level or the reception quality. At the output of the evaluation unit is that signal (particularly the low-frequency signal) that is to be played or shown. This is, for example, a radio, television or other signal. This means switching from one reception path to another reception path occurs in this context in the evaluation unit.

To clarify how phase diversity can be implemented in a parallel manner by multiplication of the corresponding circuit parts for a plurality of frequencies, it shall be noted as follows. The term “Multiplication” denotes that the components that are present in FIG. 1 and that have been described are added, in supplementation, analogously for each reception path. This means a further reception path would also use at least the antennas 2, 4 and the respective HF parts 3, 5, where the HF part has a further wideband converter connected downstream. This wideband converter would then be connected downstream to the corresponding number of mixers as in the other reception paths, similarly as the adding or omitting of the IF filter. The output signals of the additional mixers and/or the output signals of the additional IF filters would be expediently routed to further phase-diversity units and further demodulators downstream thereof.

List of reference signs

| | |
|---|---|
| 1 | Receiver |
| 2 | First antenna |
| 3 | First HF part |
| 4 | Further antenna |
| 5 | Further HF part |
| 6 | First wideband converter |
| 7 | Further wideband converter |
| 8 | Mixer |
| 9 | Mixer |
| 10 | Mixer |
| 11 | Mixer |
| 12 | Mixer |
| 13 | Mixer |
| 14 | IF filter |
| 15 | IF filter |
| 16 | IF filter |
| 17 | IF filter |
| 18 | IF filter |
| 19 | IF filter |
| 20 | Oscillator |
| 21 | Oscillator |
| 22 | Oscillator |
| 23 | Phase-diversity unit |
| 24 | Phase-diversity unit |
| 25 | Phase-diversity unit |
| 26 | Demodulator |
| 27 | Demodulator |
| 28 | Demodulator |

1. A method of operating a receiver for radio-frequency signals, the method comprising the steps of:
providing at least two antennas for receiving and further processing respective radio-frequency signals;
converting with a respective wideband converter the entire frequency range of the radio-frequency signals received by each of the antennas from analog to respective digital signals;
determining the reception quality of the received radio-frequency signals based on the digital signals; and
selecting and switching to the frequency to be used based on the determined reception quality.

2. The method according to claim 1, further comprising the steps of:
routing the digital signals to at least one mixer; and
multiplying the signals in the mixer by at least one signal of at least one oscillator to produce at least one IF signal.

3. The method according to claim 2, wherein the signal of the at least one oscillator is generated by a numerically controlled oscillator.

4. The method according to claim 3, further comprising the step of:
routing the at least one IF signal to an IF filter.

5. The method according to claim 3, further comprising the step of:
routing the at least one IF signal to a phase-diversity unit; and thereafter
routing the IF signal to a demodulator.

6. The method according to claim 5, further comprising the steps of:
routing the digital output signal of each reception path from the respective wideband converter to the respective mixer, multiplied by the signal of the respective oscillator; and
routing an IF signal obtained for each reception path to the respective phase-diversity unit.

7. The method according to claim 1, wherein an IF signal obtained from each reception path is routed to a respective phase-diversity unit.

8. The method according to claim 1, wherein, either
the frequency selection is effected for the same program that is to be played or shown on three different alternate frequencies, or
for two alternate frequencies switching is effected between these two receiving frequencies depending on the reception quality, wherein it is possible to simultaneously receive another program in the background.

9. A receiver for the reception and processing of radio-frequency signals constituted for the implementation of the method according claim 1.
